(19) United States
(12) Patent Application Publication
(10) Pub. No.: US 2026/0310606 A1
(43) Pub. Date: Oct. 8, 2026

(54) EFFICIENT DEALLOCATION FOR DATA RECOVERY IN A DATA STORAGE DEVICE

(71) Applicant: Microchip Technology Incorporated, Chandler, AZ (US)

(72) Inventors: Saswati Das, Milpitas, CA (US); Srinivas Yelisetti, Fremont, CA (US); Nian Niles Yang, Mountain View, CA (US)

(73) Assignee: Microchip Technology Incorporated, Chandler, AZ (US)

(21) Appl. No.: 19/269,412

(22) Filed: Jul. 15, 2025

Related U.S. Application Data
(60) Provisional application No. 63/785,424, filed on Apr. 8, 2025.

(51) Int. Cl. G06F 12/0871; G06F 12/02

(52) U.S. Cl. CPC G06F 12/0871; G06F 12/0246

(57) ABSTRACT

A computer-implemented method, media, and systems for setting a deallocate value for a flag within a data storage device may include: receiving, by the data storage device, a command from a host; dividing, based on the command, a range of logical block addresses corresponding to the data storage device into cache-aligned sub-ranges; determining that the sub-ranges include a full cache line; and setting, based on the command and the determination that the sub-ranges include the full cache line, the deallocate value for the flag in the full cache line.

### CROSS-REFERENCE TO RELATED APPLICATIONS

The current patent application claims the benefit under 35 U.S.C. § 119(e) of the priority date of U.S. Provisional Application Ser. No. 63/785,424 titled “EFFICIENT DEALLOCATION FOR DATA RECOVERY IN A NAND FLASH DEVICE” and filed Apr. 8, 2025. The Provisional Application is hereby incorporated by reference, in its entirety, into the current patent application.

### TECHNICAL FIELD

Various examples of the present disclosure relate to an apparatus and a method for deallocation in a data storage device (DSD), such as NOT-AND (NAND) flash-based DSDs (e.g., solid-state drives (SSDs)), for improved data recovery and increased device performance.

### BACKGROUND

Dynamic access, translation, transferring, reading, and writing of data can take place between a host, such as an operating system (OS), and a DSD communicatively coupled thereto. Logical-to-physical (L2P) address translation is an aspect of many such operations. Fast, accurate, and reliable L2P mapping and/or unmapping is necessary in high-capacity (e.g., larger than 16 terabytes (TB)) DSDs, such as the SSDs utilized in hyperscale data center solutions (DCS) and artificial intelligence (AI) applications and infrastructure.

This background discussion is intended to provide information related to the present invention which is not necessarily prior art.

### SUMMARY OF THE INVENTION

According to various examples of the present disclosure, a computer-implemented method for setting a deallocate value for a flag within a DSD may include: receiving, by the DSD, a command from a host; dividing, based on the command, a range of logical block addresses corresponding to the DSD into cache-aligned sub-ranges; determining that the sub-ranges include a full cache line; and setting, based on the command and the determination that the sub-ranges include a full cache line, the deallocate value for the flag in the full cache line.

In various other examples, a computer-implemented method for performing an operation on data stored in a cache line of a DSD may include receiving, by the DSD, a command from a host; setting, based on the command, a value for a flag within the cache line; and performing, based on the value for the flag, the operation.

In various examples, a DSD may include a memory element, computer-readable instructions, and at least one processor, the memory element storing a L2P table comprising a plurality of cache lines, and the computer-readable instructions, when executed by the at least one processor, causing the at least one processor to manage data contained in the plurality of cache lines by setting values for deallocation flags corresponding to the plurality of cache lines, the setting of the values being responsive to corresponding deallocation commands from a host communicatively coupled to the DSD.

This summary is not intended to identify essential features of the examples, and is not intended to be used to limit the scope of the claims. These and other aspects of the present examples are described below in greater detail.

### BRIEF DESCRIPTION OF THE DRAWINGS

FIG. 1 illustrates an example environmental view of a system for efficient deallocation in a NAND flash device;

FIG. 2 illustrates an example computing system configured to perform operations in accordance with various examples of the present disclosure;

FIG. 3 illustrates an example non-volatile memory (NVM) media of the system of FIG. 1;

FIG. 4 illustrates an example cache line that may be utilized in efficient deallocation in accordance with various examples of the present disclosure;

FIG. 5 illustrates an example method for efficient deallocation in accordance with various examples of the present disclosure;

FIG. 6 illustrates an example method for a background deallocation process in accordance with the various examples of the present disclosure;

FIG. 7 illustrates an example method for an undeallocation process in accordance with the various examples of the present disclosure; and

FIG. 8 illustrates an example method for a write process in accordance with the various examples of the present disclosure.

### DETAILED DESCRIPTION

In the following detailed description, reference is made to the accompanying drawings, which form a part hereof and in which are shown, by way of illustration, specific examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure. Unless clearly understood or expressly identified otherwise, structures, materials, procedures, operations, and other aspects described in the context of one example may be incorporated into other examples.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

Terms of relative location and direction (e.g., above, below, left, right, upper, lower, vertical, horizontal, lateral, and the like) may be used to facilitate the present descriptions of examples with reference to the figures, but unless clearly understood or expressly identified otherwise, these terms are not meant to be limiting with regard to location, direction, or overall orientation, and may, for example, change as a result of a change in overall orientation.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example or this disclosure to the specified components, operations, features, functions, or the like.

It will be readily understood that the components of the examples as generally described herein and illustrated in the drawings could be arranged and designed in a wide variety of different configurations. Thus, the following description of various examples is not intended to limit the scope of the present disclosure but is merely representative of various examples.

In various examples of the present disclosure, a DSD may include a data storage component and a controller. The data storage component may store data. The DSD may be connected to a host system. In various examples, the DSD may be connected to the host system by wired or wireless means. In various examples, the DSD may be connected to more than one host system, such as in a multi-tenant environment, without limitation. Also or alternatively, the host system may be connected to more than one DSD. In various examples, the host may be a memory management unit (or MMU) included in, and/or the operating system (OS) executing on, the computing device in which the affected DSD is included or to which the affected DSD is communicatively coupled.

During ordinary use of a DSD, such as a NAND-based flash device (e.g., a SSD): data that is currently stored on the DSD may be read or otherwise accessed; data may be transferred to/from the DSD; new data may be programmed, or written, to the DSD; and/or data may be deleted, or erased, from the DSD. In the event that data is deleted from the device, it is possible that the host may be “aware” (or reconfigured to reflect) that a block(s) and/or a sector(s) of the DSD was freed up by the data being erased, while the controller included in and/or communicatively coupled to the DSD is not. Deallocation seeks to rectify this disparity.

Broadly, “deallocation” may refer to a process of a host notifying a DSD that is communicatively coupled thereto (e.g., via a series of commands issued from the host to a deallocation component included in a flash controller included in the corresponding DSD(s)) that specific blocks and/or sectors included in the DSD no longer contain valid data. The host informing the DSD that blocks/sectors are now available allows those blocks/sectors to be reclaimed by, or otherwise made available to, the DSD for future use. As used throughout the present disclosure, the term “deallocate(d)” may mean “mark(ed), or flag(ged), for deallocation.” In these examples, deallocated data (e.g., data that has been marked for deallocation) may be indicated by a flag (e.g., a deallocation flag, or a DA flag) included in the cache line that is presently storing the deallocated data or a representation thereof or reference thereto. Corresponding unmapping operations and/or valid data frame count (VDF) reduction operations for the marked data may occur at a subsequent point in time (e.g., as the NAND flash device(s) including the cache line(s) including the deallocated data are idling).

A command, or series of commands issued by the host may be used to deallocate data stored in a DSD. Historically, examples of the commands include: TRIM commands for devices based on Serial ATA (SATA), UNMAP commands for devices based on Small Computer Interface (SCSI), and DEALLOCATE commands for devices based on Non-Volatile Memory Express (NVMe).

While the various examples and other discussion presented herein may broadly refer to or otherwise utilize “deallocate,” “deallocated,” and/or “deallocation” as umbrella terms for the three (3) types of commands referenced in the preceding paragraph (e.g., TRIM, UNMAP, and DEALLOCATION), it will be appreciated that the actual command(s) issued by host(s) to the corresponding DSD(s) coupled thereto may vary, as described above. For instance, in practice, UNMAP commands may be issued by the host(s) if the DSD(s) with which the host(s) is communicating follows the SCSI protocol while DEALLOCATE commands may be issued if the DSD(s) abides by the NVMe protocol.

Broadly, a logical (or virtual) address refers to an address used by a host to access data stored on a DSD that is included in, or communicatively coupled to a computing device (e.g., laptop, personal computer, mobile device, or server, without limitation). Logical addresses are abstractions, or conceptual interpretations/representations of the physical storage media (e.g., the NAND flash) included in a DSD. Logical addresses are often expressed as sequences of letters and numbers (e.g., in hexadecimal). A “logical address space” may refer to all logical addresses corresponding to a group, or unit (e.g., block, sector, wordline, without limitation), of physical addresses within/across a DSD(s). A logical address space(s) of a DSD(s) is continuous.

A physical address of a DSD is the actual physical location, or position (e.g., block, sector, page, wordline, cell, without limitation) within the physical storage media comprising the DSD on which data is stored within the DSD. Logical addresses are used to identify, or point to, physical addresses included in a DSD/across an array of DSDs. A physical address space(s) of a DSD(s) is not inherently continuous.

A L2P table may be used to map logical addresses used by the host to corresponding physical addresses within a DSD/across an array of DSDs. This mapping enables the host to treat the physical storage space of the corresponding DSD(s) as a continuous address space.

Performing deallocation based on the value of a flag in the corresponding cache line(s) as described herein may offer the benefits of expedited data recovery in the event deallocation commands are inadvertently issued by a host. Further, the flag-based deallocation described herein may improve latency of issued deallocations commands, thereby improving quality of service (QOS), particularly of large (e.g., greater than 16 terabyte (TB)) SSDs, as data can correspondingly be deallocated on a per cache line basis, rather than more generally in the entire L2P table all at once.

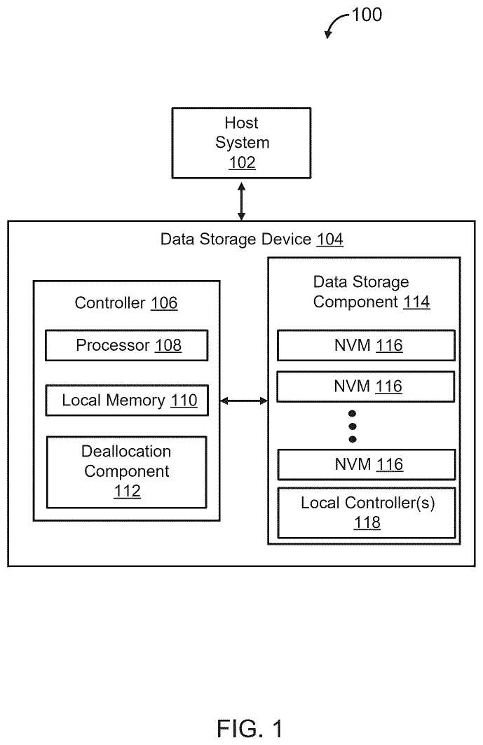

FIG. 1 illustrates an example system 100 including a host system 102 and a data storage device (or DSD) 104 that is communicatively coupled to the host system 102. The DSD 104 may include a controller 106. The controller 106 may include a processor 108, a local memory 110, and a deallocation component 112. The DSD 104 may also include a data storage component 114. The data storage component 114 may include a plurality of non-volatile data storage media (NVM) 116 and one or more local controller(s) 118. The host system 102 may communicate with the controller 106, either directly, and/or by way of one or more of the local controllers 118 included in the data storage component 114.

In various examples, a read or write request may be received from the host system 102 via a peripheral component interconnect express (PCIe) interface that connects the DSD 104 to servers or central processing units (CPUs). PCIe is a standardized interface for motherboard components. In various examples, the DSD 104 may be connected to the host system 102 by wired or wireless means (e.g., through a communications network). The DSD 104 may be connected to more than one host system (e.g., multiple instances of the host system 102), such as in a multi-tenant environment, without limitation. Also or alternatively, multiple DSDs 104 may be connected to a single host system 102.

When a data request is received from the host system 102, the controller 106 references the L2P mapping table to determine the PBA within the NVM 116 corresponding to a desired LBA. Once the PBA is determined, the controller 106 accesses the appropriate NVM 116 to write or read the data. Access to the NVM media 116 may be via a flash physical (PHY) interface. The controller 106 may employ an error correction code (ECC) operation during encoding and decoding data to detect and correct errors and enhance data integrity. Additionally, the data storage component 114 may support a direct memory access (DMA) operation enabling data to be written from the host system 102 directly to the NVM 116 and read from the NVM 116 directly to the host system 102. Certain commands may be issued to the controller 106 or the local controller(s) 118 using the host command layer, or non-volatile memory express management interface (NVMe-MI).

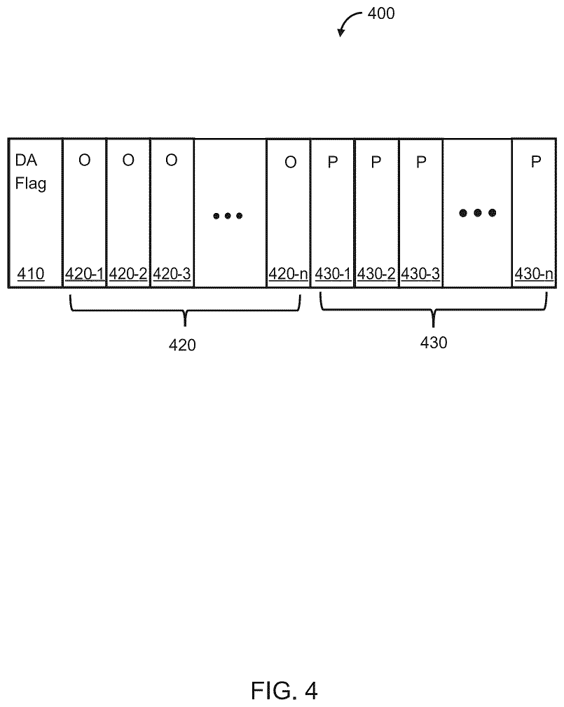

The L2P table may include a plurality of cache lines, each of which may include multiple bits. According to various examples of the present disclosure, one of the bits included in each of the cache lines may correspond to a DA flag. The remaining bits included in each of the cache lines may be used (e.g., currently storing data), unused (e.g., currently erased or otherwise available to store data), or a combination thereof. The cache line(s) are discussed in more detail below in connection with FIG. 4.

In various examples, the DSD 104 may be an SSD and the NVM 116 may be NAND-based flash memory. It would be appreciated by one of ordinary skill in the art that other DSDs (e.g., NOR flash memory, random access memory, and the like) may be utilized in the various examples described herein without departing from the spirit of the present disclosure.

The deallocation component 112 included in the DSD 104 may receive and/or process a command, or series of commands, from the host system 102 notifying, or otherwise informing, the DSD 104 that one or more blocks and/or sectors included therein no longer contain valid data, and are therefore available to have new data written thereto.

In various examples, the deallocation component 112 may receive and/or process DEALLOCATION commands from the host system 102. However, as mentioned above, it will be appreciated that the deallocation component 112 may be operable to receive and/or process TRIM and/or UNMAP commands in addition or alternatively to DEALLOCATION commands, depending, as described above, on the type of DSDs 104 that are coupled thereto.

In various examples, a system may include at least one NVMe-based DSD, at least one SATA-based DSD, and at least one SCSI-based DSD. A corresponding single deallocation component operable to receive and/or process DEALLOCATION commands may be included in each of the NVMe-based data storage systems, a single deallocation component operable to receive and/or process TRIM commands may be included in each of the SATA-based data storage system(s), and a single deallocation component operable to receive and/or process UNMAP commands may be included in each of the SCSI-based data storage systems. Alternatively a single deallocation component operable to receive and/or process DEALLOCATION commands, TRIM commands, and UNMAP commands may be included in each DSD.

It will be appreciated that the deallocation component(s) included in each DSD may be configurable to receive any number of DEALLOCATION, TRIM, and/or UNMAP commands. It will also be appreciated that each DSD may include multiple deallocation components (e.g., the deallocation component 112 of FIG. 1) in order for the system to achieve operability across the full breadth of the various protocols that may be supported by the DSD(s) included in the system.

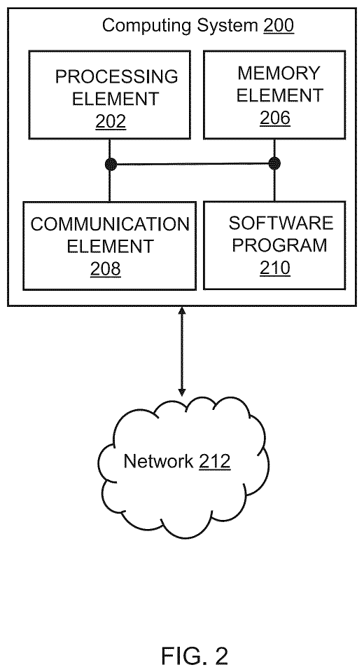

FIG. 2 illustrates a computing system 200 connected to a communication network 212. The computing system 200 may include at least one processing element 202, at least one memory element 206, a communication element 208, and a software program 210. In various examples, the computing system 200 may be a host system (e.g., the host system 102 of FIG. 1) and/or a data storage system (e.g., the DSD 104 of FIG. 1), without limitation.

The software program 210 may be configured with instructions for performing and/or enabling performance of at least some of the operations set forth herein. In an embodiment, the software program 210 comprises instructions stored on computer-readable media of memory element 206. In various examples, the software program 210 may include instructions for performing operations of the deallocation component 112 discussed with reference to FIG. 1.

The communication network 212 generally allows communication between the computing system 200 and another computing device, such as between a remote host system (e.g., the host system 102), a local host system, and/or a data storage system (e.g., the DSD 104 of FIG. 1), without limitation.

The communication network 212 may include the Internet, cellular communication networks, local area networks, metro area networks, wide area networks, cloud networks, plain old telephone service (POTS) networks, and the like, or combinations thereof. The communication network 212 may be wired, wireless, or combinations thereof and may include components such as modems, gateways, switches, routers, hubs, access points, repeaters, towers, and the like. The computing system 200 may, for example, connect to the communication network 212 either through wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

The communication element 208 generally allows communication between the computing system 200 and the communication network 212. The communication element 208 may include signal or data transmitting and receiving circuits, such as antennas, amplifiers, filters, mixers, oscillators, digital signal processors (DSPs), and the like. The communication element 208 may establish communication wirelessly by utilizing radio frequency (RF) signals and/or data that comply with communication standards such as cellular 2G, 3G, 4G or 5G, Institute of Electrical and Electronics Engineers (IEEE) 802.11 standard, such as WiFi, IEEE 802.16 standard, such as WiMAX, Bluetooth™, or combinations thereof. In addition, the communication element 208 may utilize communication standards such as ANT, ANT+, Bluetooth™ low energy (BLE), the industrial, scientific, and medical (ISM) band at 2.4 gigahertz (GHz), or the like. Alternatively, or in addition, the communication element 208 may establish communication through connectors or couplers that receive metal conductor wires or cables, like Cat 6 or coax cable, which are compatible with networking technologies such as ethernet. In certain embodiments, the communication element 208 may also couple with optical fiber cables. The communication element 208 may respectively be in communication with the processing element 202 and/or the memory element 206.

The memory element 206 may include electronic hardware data storage components such as read-only memory (ROM), programmable ROM, erasable programmable ROM, random-access memory (RAM) such as static RAM (SRAM) or dynamic RAM (DRAM), solid state drives (SSDs), cache memory, hard disks, floppy disks, optical disks, flash memory, thumb drives, universal serial bus (USB) drives, or the like, or combinations thereof. In some embodiments, the memory element 206 may be embedded in, or packaged in the same package as, the processing element 202. The memory element 206 may include, or may constitute, a “computer-readable medium.” The memory element 206 may store the instructions, code, code segments, software, firmware, programs, applications, apps, services, daemons, or the like that are executed by the processing element 202. In an embodiment, the memory element 206 stores the software applications/program 210. The memory element 206 may also store settings, data, documents, sound files, photographs, movies, images, databases, and the like. In various examples, the memory element 206 may include a first memory component (e.g., the local memory 110 of FIG. 1) and one or more SSDs (e.g., the DSD 104 of FIG. 1).

The processing element 202 may include electronic hardware components such as processors. The processing element 202 may include digital processing unit(s). The processing element 202 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing element 202 may generally execute, process, or run instructions, code, code segments, software, firmware, programs, applications, apps, processes, services, daemons, or the like. For instance, the processing element 202 may respectively execute the software applications/program 210. The processing element 202 may also include hardware components such as finite-state machines, sequential and combinational logic, and other electronic circuits that can perform the functions necessary for the operation of the current disclosure. The processing element 202 may be in communication with the other electronic components through serial or parallel links that include universal busses, address busses, data busses, control lines, and the like.

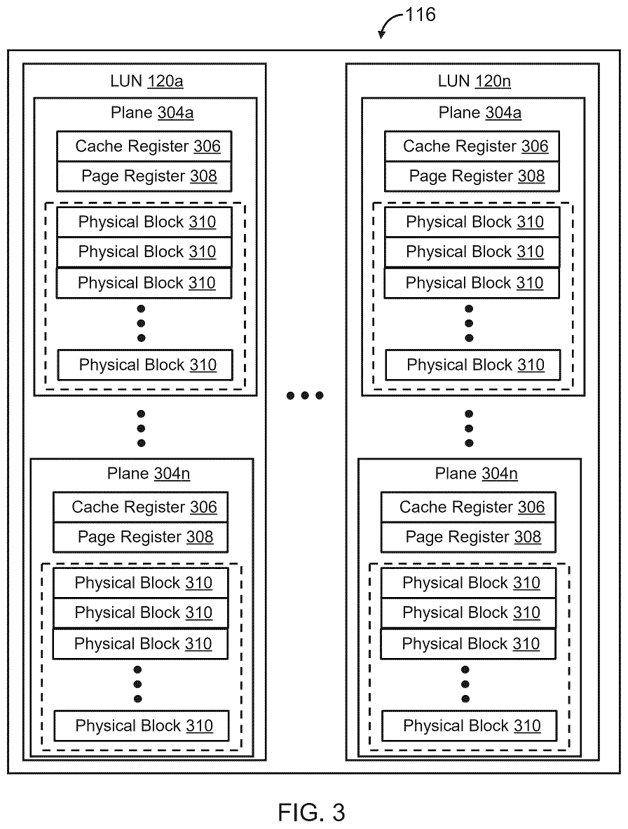

Turning to FIG. 3, the NVM 116 may respectively include a plurality of dies. In various examples, the NVM media 116 may respectively include two (2), four (4), eight (8), sixteen (16), twenty four (24), thirty two (32), or more dies, without limitation. Each die may correspond to a logical unit (LUN). Each NVM 116 may include LUNs 120a, . . . 120n. Each LUN 120a, . . . 120n may include a plurality of planes 304a, . . . 304n. Each LUN 120a, . . . 120n may include, for example, four (4), six (6), eight (8), or more planes, without limitation.

Each plane may include a cache register 306, a page register 308, and a plurality of physical memory blocks 310. In various examples, the controller 106 may write incoming data to more than one NVM media 116 in parallel. The NVM 116 may write incoming data to more than one LUN in parallel.

When data is written to or retrieved from the NVM 116, the data may be temporarily stored in one of the cache register 306 and the page register 308. Each physical memory block 310 may include a set of pages. The cache register 306 and the page register 308 may respectively have an equivalent data capacity of one page. Accordingly, data to be written to a first page may be temporarily stored in the cache register 306 while data to be written to another page may be temporarily stored in the page register 308. Data to be read from a first page may be retrieved and temporarily stored in the cache register 306 while data to be read from another page may be stored in the page register 308. Accordingly, the cache register 306 and page register 308 enable double buffering of data to reduce data programming and read times.

FIG. 4 illustrates an example full cache line 400 of an example L2P table. More particularly, in various examples, the full cache line 400 may be included in the upper most DWORD of an L2P entry of a 64-byte cache line. Generally, a “DWORD” is a 32-bit (or 4 byte) integer that can hold values ranging from −2\hat{ }31 to (2\hat{ }31)−1. DA Flag 410 may be included in the full cache line 400, and may be a single bit of the full cache line 400. As such, the full cache line 400 includes a total of thirty-three (33) bits. The bits 420-1, 420-2, 420-3, . . . , 420-n may be open (as denoted by the letter “O” included at the top of each rectangle demarking each corresponding bit), or otherwise unused. The bits 420-1, 420-2, 420-3, . . . , 420-n may be referred to collectively as “the open bits 420.” The bits 430-1, 430-2, 430-3, . . . , 430-n may be programmed (as denoted by the letter “P” included at the top of each rectangle demarking each corresponding bit) with the last “n” bits of the greater 64-byte cache line from which the full cache line 400 is formed. The bits 430-1, 430-2, 430-3, . . . , 430-n may be referred to collectively as “the programmed bits 430.” In examples where the full cache line 400 includes 33 bits total, e.g., the one (1) DA flag bit 410 and thirty-two (32) additional bits, the additional bits may comprise any combination of open bits (e.g., the open bits 420) and any number of programmed bits (e.g., the programmed bits 430) so long as the sum of the open bits and programmed bits included in the cache line 400 equals thirty-two (32).

In various other examples, the full cache line 400 may include more or less than thirty-three (33) bits. Generally, the full cache line 400 may include thirty-two (32) to thirty-six (36) bits, inclusive. However, regardless of the total size of the full cache line 400, in accordance with various examples of the present disclosure, there will be a single DA flag 410 per full cache line 400, and the DA flag 410 will be represented as one (1) bit thereof. For instance, the full cache line 400 may include thirty-five (35) bits. One (1) bit may be the DA flag 410. The additional thirty-four (34) bits included in this second example full cache line 400 may be any combination of programmed and open bits 430, 420, so long as there are thirty-four (34) total additional bits included in the full cache line 400.

In various examples, the value of the DA flag 410 may correspond to the deallocation status of the full cache line 400. For instance, as depicted in FIG. 4, there is a mix of programmed and open bits 430, 420 in the full cache line 400. The value of the DA Flag 410 may be set to zero (0). A DA flag value of zero (0) may indicate (e.g., to the DSD controller) that the deallocation status of the full cache line 400 is either not fully deallocated or that unmapping has already been completed for any deallocated entries of the full cache line.

According to examples of the present disclosure, any deallocation that has yet to be performed on full cache lines having a DA flag set to one (1) may be performed in the background (e.g., when the DSD including the corresponding full cache lines are idle). Additional details on this background deallocation process are provided elsewhere herein. If the full cache line 400 were to include all open, or erased bits, the DA Flag 410 may be set to zero (0). The DA Flag 410 being set to zero (0) may alternatively indicate data stored in the full cache line 400 is fully deallocated (e.g., that all data marked for deallocation included in the corresponding cache line has been unmapped).

In various examples, a DSD (e.g., the DSD 104 of FIG. 1) may be configured to include a L2P table comprising a plurality of cache lines, including one or more full cache lines (e.g., the full cache line 400 of FIG. 4). As above, each of the cache lines included in the L2P table may include thirty-two (32) to thirty-six (36) bits, inclusive. In these, and similar examples, the DSD may be configured to recognize a first bit of each of the plurality of cache lines as a deallocation flag (e.g., the DA flag 410 of FIG. 4) for the corresponding one of the plurality of cache lines.

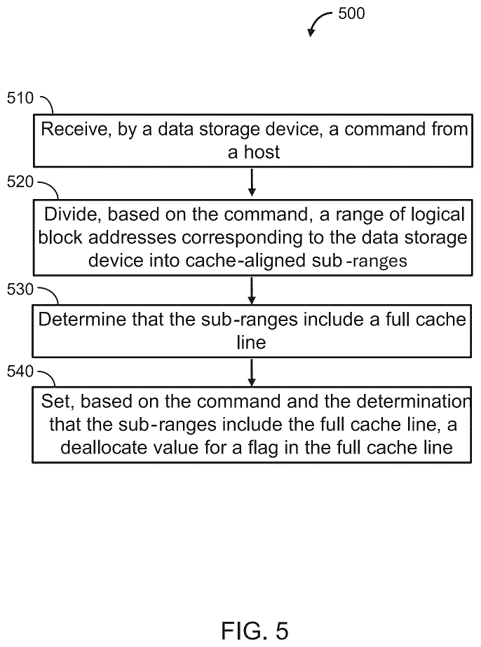

One of ordinary skill will appreciate that the numerical value of a DA flag and its logical meaning may be the inverse of that described in the preceding paragraph within the scope of the present examples. Additional details related to the deallocation statuses mentioned above are provided in the description of FIG. 5 below.

FIGS. 5-8 illustrate example methods 500, 600, 700, 800 for managing deallocation in a DSD, such as a NAND flash device, based on DA flag values (e.g., the DA Flag 410 of FIG. 4). The methods 500, 600, 700, 800 may be performed on/by the DSD 104 of FIG. 1. The operations may be performed in the order shown in respective method flows depicted in FIGS. 5-8, or they may be performed in a different order. Further, some operations may be performed concurrently as opposed to sequentially, and some operations may be optional.

The methods 500, 600, 700, 800 may be performed by a host system (e.g., the host system 102 of FIG. 1) entirely, a controller (e.g., the controller 106 and/or controller(s) 118 of FIG. 1), or a combination of the host system and controller. The methods 500, 600, 700, 800 may operate on block(s) of non-volatile memory media (e.g., NVM 116 included in the DSD 104) described in more detail above in connection with FIGS. 1-4. However, a person having ordinary skill will appreciate that responsibility for all or some of the operations described herein may be distributed differently among such DSDs or other computing devices, and/or may operate on one or more other memory types or media, without departing from the spirit of the present disclosure.

The controller(s) may receive a command, or a series of commands, e.g., one or more of the DEALLOCATION commands discussed above. Upon receiving said command(s) the controller(s) may mark data stored in or by the data storage system for deallocation and complete additional operations dependent thereon, in accordance with the operations described below.

One or more computer-readable medium(s) may also be provided. The computer-readable medium(s) may include one or more executable programs stored thereon, such as firmware programs, wherein the program(s) instruct one or more processing elements to perform all or certain of the steps or operations outlined herein. The program(s) stored on the computer-readable medium(s) may instruct the processing element(s) to perform additional, fewer, or alternative actions, including those discussed elsewhere herein.

Referring to FIG. 5, a computer-implemented method for setting a deallocate value for a flag (e.g., a DA flag such as the DA flag 410 of FIG. 4) within a DSD is depicted. At operation 510, a command may be received by a DSD from a host. For example, the DSD may be the DSD 104 of FIG. 1. The command may be received and/or processed by a deallocation component (e.g., the deallocation component 112 of FIG. 1) included in the DSD. The command may comprise a single command (e.g., a DEALLOCATION command), or a series of (DEALLOCATION) commands from the host(s) (e.g., the host system 102 of FIG. 1) communicatively coupled to the DSD.

According to various examples, the DEALLOCATION command(s) may be transmitted locally (e.g., via PCIe, NVMe, NVMe-MI, SCSI, SATA, or other similar protocols that facilitate communication between components included in the same computing device). Also or alternatively, the DEALLOCATION command(s) may be transmitted over a network (e.g., via WiFi, POTs, and/or any combination of networks described in connection with FIG. 2), for example if the host system(s) and the data storage system(s) coupled thereto are disparate or discrete devices.

At operation 520, a range of logical block addresses (LBAs) corresponding to the DSD may be divided into cache-aligned sub-ranges. In various examples, the LBAs may be pointed to, referenced by, and/or included in the command(s) received at operation 510. Broadly, the logical address space described above may comprise a plurality of LBAs, wherein each LBA corresponds to a particular block, or sector, of the overall logical address space of the corresponding DSD(s). LBAs may be represented as a string of letters and/or numbers. These cache-aligned sub-ranges may be the above-mentioned plurality of cache lines, and particular ones of the plurality of cache lines may be a full cache line (e.g., the full cache line 400 of FIG. 4).

At operation 530, a determination as to whether the sub-ranges (e.g., plurality of cache lines) include a full cache line is made. This decision may be made by one or more of the host system and one or more controllers (e.g., the controller 106 and/or one or more of the local controllers 118 of FIG. 1). For non-full cache lines of the sub-range (e.g., for cache line unaligned head and tail sub-ranges) individual entries in the L2P table corresponding to the cache line may be unmapped. Further, VDF count for a virtual block(s) corresponding to each of the unmapped data entries may be reduced. Reducing VDF count in such a manner may increase overall performance of the DSD(s) on which the operation 530 was performed.

At operation 540, based on the command(s) received at operation 510 and the determination that the sub-ranges include the full cache line at operation 530, a deallocate value for a flag (e.g., the DA flag 410 of FIG. 4) in the full cache line is set. The deallocate value of the DA flag may be set to zero (0) or one (1). A deallocate value of zero (0) may correspond to a deallocation status for the full cache line indicating that less than the entirety of the cache line is designated for deallocation or that unmapping and VDF count reduction have already been completed for any deallocated entries of the full cache line. Deallocation that has yet to be performed on the full cache lines having a deallocate value of one (1) may be performed in the background (e.g., when the DSD(s) including the corresponding full cache line(s) is idle).

As discussed above, it will be appreciated that the numerical value of a DA flag and its logical meaning being the inverse of that described in the preceding paragraph is within the scope of the present disclosure.

Responsive to all sub-ranges implicated by the command(s) being processed (e.g., once DA flags of all full cache lines have been set and other operations responsive to the command(s) have been completed), the DSD(s) on which the process comprising operations 510-540 were performed may send a command, or series of commands, and/or notification(s) that indicate or otherwise notify the host that the process comprising operations 510-540 has been completed.

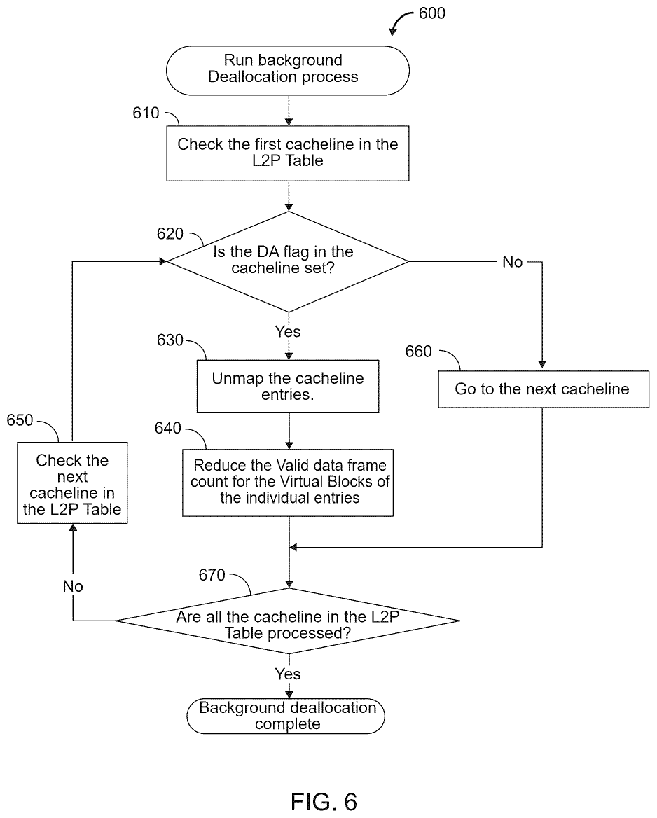

FIG. 6 illustrates an example method for performing a delayed background deallocation process 600. The delayed background deallocation process 600 may be triggered or otherwise run, for example, based on a determination of reduced activity at the DSD containing full cache line(s) with DA flag(s) of value one (1). The determination may be made by a host or by one or more controller(s) of the DSD. In various examples, the DSD may be in an idle state during performance of the process 600.

At operation 610, one or more initial or first cache lines included in an L2P table corresponding to the DSD(s) are checked for DA flag(s) set to value one (1). If, at operation 620, it is decided that the DA flag is set (i.e., to value one (1)) for the checked cache line, individual data entries (e.g., bits) in the corresponding (full) cache line(s) will be unmapped at operation 630. At operation 640, a VDF count for one or more virtual blocks corresponding to the unmapped data entries is reduced. Broadly, reducing VDF count as data is unmapped reduces the workload for the host(s) (e.g., the host system 102 of FIG. 1) and/or controller(s) (e.g., the controller 106 and/or one or more of the local controllers 118 of FIG. 1) overseeing/orchestrating the unmapping. Once this cache line is processed (e.g., once the above-described unmapping and VDF count reduction operations have been performed), at operation 650, subsequent cache lines included in the L2P table are checked and discriminately operated on in iterative fashion as illustrated in FIG. 6.

For example, if, at operation 620, it is determined that the DA flag of a given cache line being checked is not set, at operation 660 the next cache line is checked. At operation 670, once it is determined that all cache lines included in the L2P table have been checked and bypassed or processed according to the operations described above, the delayed background deallocation process 600 is terminated.

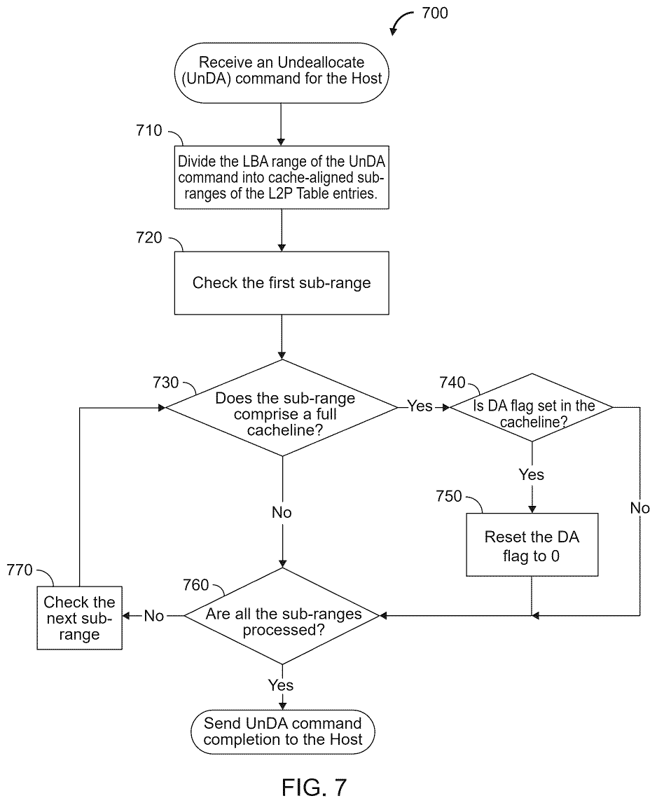

FIG. 7 illustrates an undeallocate process 700 that may be performed in accordance with the present disclosure. Broadly, undeallocation may reverse, or otherwise undo, a DA flag(s) (e.g., the DA Flag 410 of FIG. 4) that was previously set. Referring to the undeallocate process 700 depicted in FIG. 7, an undeallocate command may be received. In various examples, the command is received from the host, and is intended to recover data previously flagged for deallocation. The command may point to, reference, or include LBA(s) for one or more cache lines with a DA flag having a first value (e.g., one (1)), for example those deallocated full cache line(s) with flag(s) set to one (1) according to the example method 500 discussed in more detail above. Based on the undeallocate command, an operation including an undeallocate process, such as the undeallocation process 700, may be performed.

At operation 710, the undeallocate process 700 includes dividing an LBA range of a L2P table included in one or more DSD(s) that received, and/or are otherwise governed by or implicated in the undeallocate command, into cache-aligned sub-ranges (e.g., cache lines). As discussed above, the LBA range may be pointed to, or referenced or included in, the undeallocate command. At operation 720, one or more initial or first cache-aligned sub-range(s) of the LBA range is/are checked. At operation 730, a determination as to whether the sub-range checked at operation 720 comprises a full cache line is made.

If the cache line checked at operation 720 does comprise, or otherwise includes, a full cache line, at operation 740 a determination is made regarding whether a DA flag (e.g., the DA flag 410 of FIG. 4) included in the full cache line is set. If the DA flag is set (e.g., to one (1) in the examples discussed above), at operation 750 the DA flag has its value reset. In accordance with the examples provided above, in which a flag value of one (1) designates deallocation, operation 750 would include resetting the DA flag value to zero (0). However, it will again be appreciated that, in practice, opposite logical values of the DA flag may correspond to the DA flag being set versus unset without departing from the spirit of the present disclosure. Conversely, if the DA flag for the full cache line is not set, the DA flag is not reset. All sub-ranges of the LBA range may be checked and respectively processed through operations 720, 730, 740 (and, where appropriate, 750) in iterative fashion.

Following completion of the flag reset (operation 750) and/or determination at operation 740 that a given cache line has a DA flag which is not set, operation 760 determines whether all the sub-ranges of the LBA range have been processed according to operations 720, 730, 740 (and, where appropriate, 750). As discussed above, if all sub-ranges have not been processed, then, at operation 770, the next sub-range is checked. However, if at operation 760 it is determined that all sub-ranges have been checked, the undeallocate process 700 is terminated and/or a notification is sent to the host signaling completion of the undeallocate command.

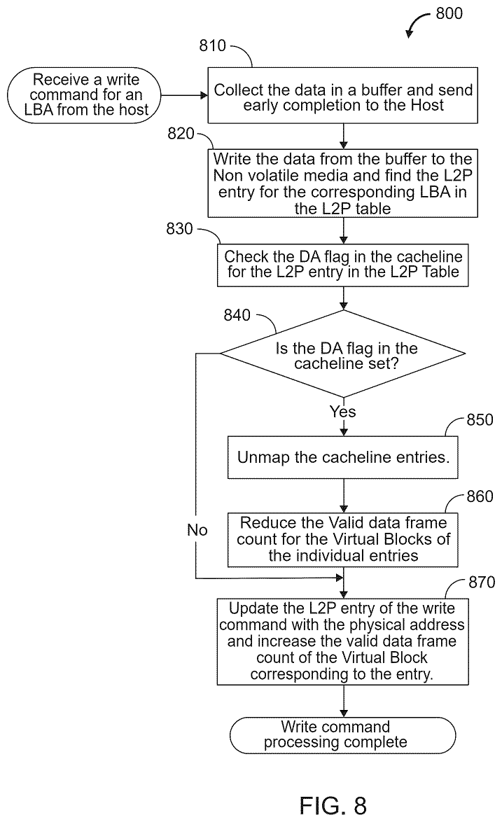

In various examples, such as where a delayed deallocation process 600 or an undeallocate process 700 has not yet been completed for one or more full cache line(s) with set DA flags (e.g., with value of one (1) under the above examples), a write command may be received for such full cache line(s). More particularly, the received write command may correspond to a LBA corresponding to a DSD that is receiving the write command from a host. A corresponding write process 800 is depicted in FIG. 8.

At operation 810, responsive to receiving the write command, data may be collected in a buffer. The data pointed to, referenced by or included with the write command may be written from a host (e.g., the host system 102 of FIG. 1) to the buffer(s), such as DRAM, before the data is written to the storage media of the DSD(s) targeted by the write command. The write command may originate with the host. The buffer may be a component of the DSD(s). At operation 810, an indication, or notification, of early completion may be sent from the targeted DSD(s) to the host(s). The notification(s) may be issued as/after data is collected in the buffer(s).

At operation 820, the data is written from the buffer to the non-volatile memory media (e.g., the NVM 116 included in the DSD 104 of FIG. 1). Further, at operation 820, one or more L2P entries corresponding to the LBA(s) of the targeted DSD(s) are identified. According to the present disclosure, a physical address, such as a physical block address (PBA), may be used to identify entries targeted by the write command. An L2P table may be used to map the LBAs and/or the logical address space to a corresponding PBA and/or a corresponding location/position within the physical address space of the DSD(s) that was targeted by the write command.

At operations 830, 840, DA flag(s) in cache line(s) corresponding to the identified L2P entries in the L2P table may be checked. If the DA flag is set for one or more of the checked cache line(s), at operation 850 data entries included in the corresponding cache line(s) are unmapped. Further, at operation 860, a VDF count for one or more virtual blocks corresponding to the data entries is reduced.

At operation 870, targeted L2P entries, including those corresponding to cache line(s) operated on pursuant to operations 850, 860 as well as any without set DA flags as determined at operation 840, may be updated with the physical address(es) written to at operation 820. Further, the VDF count for the corresponding virtual block(s) may be increased.

Responsive to all L2P entries of a write command being updated and all corresponding VDF counts being increased at operation 870, the write process 800 is terminated.

As discussed in various examples above, termination of the write process 800, the undeallocate process 700, or the delayed background deallocate process 600 may be accompanied by transmission of a notification from the corresponding DSD(s) to the host(s) from which the respective command originated, signaling the completion and/or termination. Responsive to receiving the termination notification(s) from the DSD(s), the host(s) cease performance of the corresponding process(es).

Additional details for each of the method operations/processes depicted in FIGS. 5-8 can be found in the description of FIGS. 1-4 above.

Additional processing in/for each of above-mentioned method operations/processes may be performed, as desired.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the disclosure as hereinafter claimed along with their legal equivalents. In addition, features from one example may be combined with features of another example while still being encompassed within the scope of the disclosure as contemplated by the inventors.

### FEATURE COMBINATIONS

According to various examples of the present disclosure, computer-implemented methods for setting a deallocate value for a flag within a data storage device may include: receiving, by the data storage device, a command from a host; dividing, based on the command, a range of logical block addresses corresponding to the data storage device into cache-aligned sub-ranges; determining that the sub-ranges include a full cache line; and setting, based on the command and the determination that the sub-ranges include the full cache line, a deallocate value for the flag in the full cache line.

In combination with any of the previous examples, the command may be a deallocation command and the flag may be a deallocation flag stored as one (1) bit of the full cache line.

In combination with any of the previous examples, the deallocate value of a deallocation flag may correspond to a deallocation status of data stored in the full cache line.

In combination with any of the previous examples, a deallocation status may indicate that the full cache line is either not fully deallocated, or that unmapping has already been completed for any deallocated entries of the full cache line, where the deallocate value of a deallocation flag is zero (0).

In combination with any of the previous examples, a deallocation status may indicate that data stored in the full cache line is fully deallocated where the deallocate value of a deallocate flag is one (1).

In combination with any of the previous examples, the data storage device may be configured to include a logical-to-physical (L2P) table comprising a plurality of cache lines including the full cache line.

In combination with any of the previous examples, each of a plurality of cache lines may include thirty-two (32) to thirty-six (36) bits, inclusive.

In combination with any of the previous examples, the data storage device may be configured to recognize a first bit of each of a plurality of cache lines as a deallocation flag for the corresponding one of the plurality of cache lines.

According to various additional examples of the present disclosure, computer-implemented methods for performing an operation on data stored in a cache line of a data storage device may include: receiving, by the data storage device, a command from a host; setting, based on the command, a value for a flag within the cache line; and performing, based on the value for the flag, the operation.

In combination with any of the previous examples, responsive to the value for the flag being one (1), the operation performed may include a delayed background deallocation process.

In combination with any of the previous examples, the cache line may be included in a logical-to-physical (L2P) table and a delayed background deallocation process may include: determining the flag of the cache line is set to a value; responsive to determining that the flag is set to the value, unmapping data included in and reducing a valid data frame count for one or more virtual blocks corresponding to the cache line; and terminating the delayed background deallocation process based at least in part on a determination that all cache lines of the L2P table having flags set to the value have been unmapped and reduced valid frame counts.

In combination with any of the previous examples, when a value of the flag within the cache line is a first value, a second command may be received from the host.

In combination with any of the previous examples, a second command may be an undeallocate command, and an additional operation may be performed based on the undeallocate command, the operation including an undeallocate process comprising: dividing a logical block address range corresponding to the undeallocate command into cache-aligned sub-ranges of a logical-to-physical (L2P) table that includes the cache line; determining that the cache line comprises a full cache line; and based on the determination and on the flag having a first value, resetting the value of the flag to a second value.

In combination with any of the previous examples, it may also be determined that all of the cache-aligned sub-ranges corresponding to the undeallocate command have been processed for the L2P table and, based on the determination of completed processing, a notification of undeallocate completion may be transmitted.

In combination with any of the previous examples, an operation may additionally be performed based on a second command. If the second command is a write command and the cache line is included in a logical-to-physical (L2P) table, the operation may include a write process including: writing write command data to a physical address of a non-volatile memory media included in a data storage device; determining that the value of the flag of the cache line is a first value; based on the determination of the value of the flag, unmapping present data included in and reducing a valid data frame count for one or more virtual blocks corresponding to the cache line; updating the cache line to include a physical address; and setting the value of the flag of the cache line to a second value.

### GENERAL CONSIDERATIONS

In this description, references to “one embodiment”, “an embodiment”, “embodiments”, “an example”, “one example”, or “examples” mean that the feature or features being referred to are included in at least one embodiment or example of the technology. Separate references to “one embodiment”, “an embodiment”, “embodiments”, “an example”, “one example”, or “examples” in this description do not necessarily refer to the same embodiment or example and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein, unless otherwise expressly stated and/or readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the disclosure as hereinafter claimed along with their legal equivalents. In addition, features from one example may be combined with features of another example while still being encompassed within the scope of the disclosure as contemplated by the inventors.

What is claimed is:

1. A computer-implemented method for setting a deallocate value for a flag within a data storage device, the method comprising:
receiving, by the data storage device, a command from a host;
dividing, based on the command, a range of logical block addresses corresponding to the data storage device into cache-aligned sub-ranges;
determining that the sub-ranges include a full cache line; and
setting, based on the command and the determination that the sub-ranges include the full cache line, the deallocate value for the flag in the full cache line.

2. The computer-implemented method of claim 1, wherein the command is a deallocation command, and the flag is a deallocation flag stored as one (1) bit of the full cache line.

3. The computer-implemented method of claim 2, wherein the deallocate value of the deallocation flag corresponds to a deallocation status of data stored in the full cache line.

4. The computer-implemented method of claim 3, wherein the deallocation status indicates that the full cache line is either not fully deallocated, or that unmapping has already been completed for any deallocated entries of the full cache line, where the deallocate value of the deallocation flag is zero (0).

5. The computer-implemented method of claim 3, wherein the deallocation status indicates that data stored in the full cache line is fully deallocated where the deallocate value of the deallocation flag is one (1).

6. The computer-implemented method of claim 1, wherein the data storage device is configured to include a logical-to-physical (L2P) table comprising a plurality of cache lines including the full cache line.

7. The computer-implemented method of claim 6, wherein each of the plurality of cache lines includes thirty-two (32) to thirty-six (36) bits, inclusive.

8. The computer-implemented method of claim 6, wherein the data storage device is configured to recognize a first bit of each of the plurality of cache lines as the deallocation flag for the corresponding one of the plurality of cache lines.

9. A computer-implemented method for performing an operation on data stored in a cache line of a data storage device, the method comprising:
receiving, by the data storage device, a command from a host;
setting, based on the command, a value for a flag within the cache line; and
performing, based on the value for the flag, the operation.

10. The computer-implemented method of claim 9, wherein, responsive to the value for the flag being one (1), the operation performed includes a delayed background deallocation process.

11. The computer-implemented method of claim 10, wherein the cache line is in a logical-to-physical (L2P) table and the delayed background deallocation process includes
determining the flag of the cache line is set to the value;
responsive to determining that the flag is set to the value, unmapping data included in and reducing a valid data frame count for one or more virtual blocks corresponding to the cache line; and
terminating the delayed background deallocation process based at least in part on a determination that all cache lines of the L2P table having flags set to the value have been unmapped and reduced valid frame counts.

12. The computer-implemented method of claim 9, including receiving, when the value of the flag within the cache line is a first value, a second command from the host.

13. The computer-implemented method of claim 12, wherein the second command is an undeallocate command, the operation is additionally performed based on the undeallocate command, and the operation includes an undeallocate process comprising—
dividing a logical block address range corresponding to the undeallocate command into cache-aligned sub-ranges of a logical-to-physical (L2P) table that includes the cache line;
determining that the cache line comprises a full cache line; and
based on the determination and on the flag having the first value, resetting the value of the flag to a second value.

14. The computer-implemented method of claim 13, including—determining that all of the cache-aligned sub-ranges of the undeallocate command have been processed for the L2P table; and
based on the determination of completed processing, transmit a notification of undeallocate completion.

15. The computer-implemented method of claim 12, wherein the operation is additionally performed based on the second command, the second command is a write command, and the cache line is included in a logical-to-physical (L2P) table, the operation including a write process comprising—
writing write command data to a physical address of a non-volatile memory media included in the data storage device;
determining that the value of the flag of the cache line is the first value;
based on the determination of the value of the flag, unmapping present data included in and reducing a valid data frame count for one or more virtual blocks corresponding to the cache line;
updating the cache line to include the physical address; and
setting the value of the flag of the cache line to a second value.

16. The computer-implemented method of claim 15, including—
responsive to updating the cache line to include the physical address, increasing the valid data frame count for one or more virtual blocks corresponding to the cache line.

17. A data storage device including a memory element, computer-readable instructions, and at least one processor, the memory element storing a logical-to-physical (L2P) table comprising a plurality of cache lines, and the computer-readable instructions, when executed by the at least one processor, causing the at least one processor to manage data contained in the plurality of cache lines by setting values for deallocation flags corresponding to the plurality of cache lines, the setting of the values being responsive to corresponding deallocation commands from a host communicatively coupled to the data storage device.

18. The data storage device of claim 17, wherein the managing of the plurality of cache lines includes recognizing a first deallocation value for one of the deallocation flags and, based on the first deallocation value and an undeallocate command, replacing the first deallocation value with a second deallocation value.

19. The data storage device of claim 17, wherein the managing of the plurality of cache lines includes performing a background deallocation process based on a first deallocation value for one of the deallocation flags.

20. The data storage device of claim 17, wherein the managing of the plurality of cache lines includes performing a write process based on a first deallocation value for one of the deallocation flags.
